(19) United States
(12) Patent Application Publication
(10) Pub. No.: US 2017/0002961 A1
(43) Pub. Date: Jan. 5, 2017

(54) METHOD AND APPARATUS FOR ASSEMBLY OF FLANGED OBJECTS

(71) Applicant: Martin Ugalde, Fallon, NV (US)

(72) Inventor: Martin Ugalde, Fallon, NV (US)

(21) Appl. No.: 15/197,136

(22) Filed: Jun. 29, 2016

Related U.S. Application Data
(60) Provisional application No. 62/231,237, filed on Jun. 30, 2015.

(51) Int. Cl. F16L 23/00; F16L 23/036

(52) U.S. Cl. CPC F16L 23/003; F16L 23/036

(57) ABSTRACT

Methods and an apparatus for assembly of flanged piping are disclosed. An apparatus comprises at least one plate and a plurality of apertures on the at least one plate. The plurality of apertures is spaced at predetermined intervals. Each of the plurality of apertures is a predetermined shape matching a shape of a first end of a fastener. A second end of the fastener is threaded through one of the plurality of apertures such that the first end of the fastener engages with the at least one plate at the one of the plurality of apertures and prevents rotational movement of the first end of the fastener.

### CROSS-REFERENCE TO RELATED APPLICATIONS

This application claims priority to U.S. Provisional Patent Application Ser. No. 62/231,237 all filed Jun. 30, 2015, the entire contents of which are herein incorporated by reference.

### FIELD OF THE DISCLOSURE

The present invention relates generally to methods and an apparatus for assembly of flanged objects.

### BACKGROUND

Assembly of flanged objects (e.g., flanged piping, valves, meters, fittings, etc.) requires the use of fasteners (typically bolts) threaded through a plurality of apertures spaced about the flanges. Traditional methods of assembly require the use of two wrenches by the assembler. Each bolt must be tightened either at the bolt head on one end or at the nut on the other end of the bolt. In the first method, the assembler tightens the bolt at the bolt head with the first wrench, and holds the nut in place with the second wrench to prevent movement (such as rotation) of the nut during tightening. In the second method, the assembler tightens the nut using the first wrench, and holds the bolt head in place with the second wrench to prevent movement (such as rotation) of the bolt during tightening. Using either method, the assembler must repeat the process for each bolt in the flange assembly. These traditional methods are time-consuming and cumbersome, as they require the assembler to coordinate the use of multiple tools to tighten each bolt separately.

An improved design of the invention of U.S. Pat. No. 5,429,465, issued to Stephen T. Puskas on Jul. 4, 1995, disclosed using a plurality of wedges that fit together to form a circle to cover a flange and prevent rotation of the bolts during assembly. Although this design is an improvement over traditional manual assembly, it requires numerous separate wedges (the disclosed embodiment, for example, uses eight wedges) to be matched together to form a complete ring. Aligning the wedges of this design also requires additional time and labor by the assembler.

The present invention is aimed at one or more of the problems identified above.

### BRIEF SUMMARY OF THE INVENTION

In one embodiment, an apparatus for assembly of flanged piping is provided. An apparatus comprises at least one plate and a plurality of apertures on the at least one plate. The plurality of apertures is spaced at predetermined intervals. Each of the plurality of apertures is a predetermined shape matching a shape of a first end of a fastener. A second end of the fastener is threaded through one of the plurality of apertures such that the first end of the fastener engages with the at least one plate at the one of the plurality of apertures and prevents rotational movement of the first end of the fastener.

In another embodiment, a method for assembly of flanged piping is provided A first flange containing a plurality of apertures is aligned to a second flange containing a plurality of apertures, where one of the plurality of apertures of the first flange is aligned to one of the plurality of apertures of the second flange to form a single, continuous aperture. A plurality of fasteners is threaded through each of the continuous flange apertures. At least one plate is engaged with a first end of the fasteners. For instance, the at least one plate may be engaged at the first end with either the heads or nuts of a bolt. The fasteners are tightened at a second end (e.g., the nuts, if the first end comprises heads; or the heads, if the first end comprises nuts). The at least one plate holds the first end of the fasteners in place during the tightening to prevent movement or rotation of the first end.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a front view of a plate apparatus for assembly of flanged objects;

FIG. 2 is a side view of an assembly of flanged objects coupled to exemplary flanges using a plate apparatus;

FIG. 3 is a side view of an exemplary flanged piping assembly; and

FIG. 4 is a flowchart illustrating a method for assembling flanged objects.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or subcombinations in one or more embodiments or examples. In addition, it is appreciated that the figures provided herewith are for explanation purposes to persons ordinarily skilled in the art and that the drawings are not necessarily drawn to scale.

The present invention provides methods and an apparatus to reduce time and effort required to manually assemble flanged objects. It is contemplated that the present invention may be used with flanged piping, valves, meters, fittings, and any other flanged object. By way of example and not limitation, the present invention may be used in assembly of oil, gas, water, and wastewater pipeline systems. Flanged objects, such as piping, may be comprised of any suitable material, including but not limited to PVC, HDPE, steel, or ductile iron.

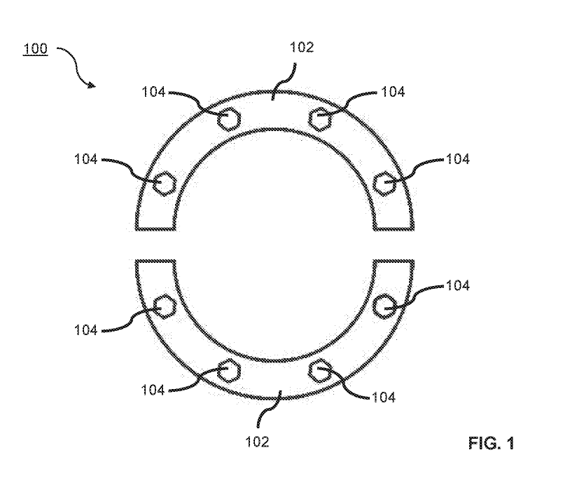

Referring now to FIG. 1, a front view of a plate apparatus 100 for assembly of flanged objects is shown. Apparatus 100 is comprised of two independent, identical plates 102. Each plate 102 may comprise a half-ring. Each plate 102 includes a plurality of apertures 104, which may be arranged in any configuration. By way of example and not limitation, a typical flange may include one aperture every 45°, for a total of eight apertures. In the illustrated embodiment, each plate 102 includes four aperture 104 spaced at 45° increments.

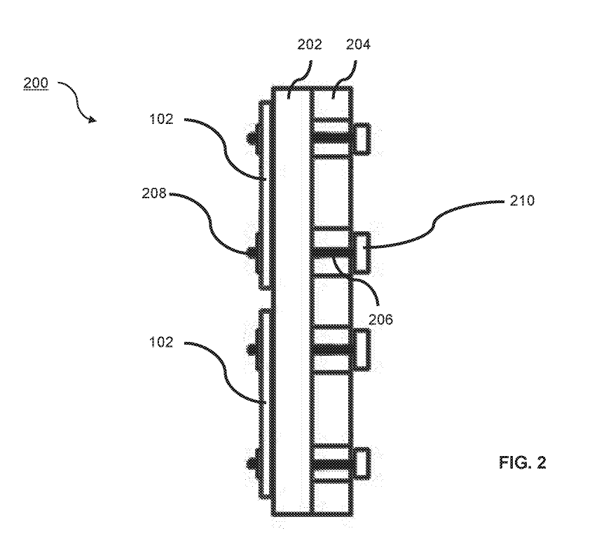

Referring now to FIG. 2, a side view of an assembly 200 of flanged objects coupled to exemplary flanges 202, 204 using the plate apparatus 100 is shown. A plurality of fasteners, one of which is labeled 206, is threaded through flanges 202 and 204. Fastener 206 includes nut 208 and head 210. In the illustrated embodiment, plates 102 are engaged with nuts 208, allowing the assembler to tighten heads 210 and prevent movement or rotation of all of the nuts 208 during assembly. In an alternate embodiment, plates 102 may be engaged with heads 210 to allow tightening of nuts 208 and prevent movement or rotation of heads 210.

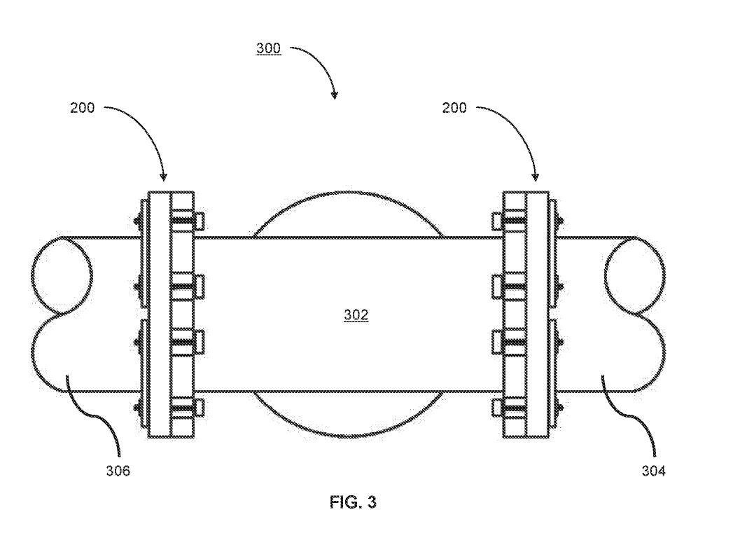

Referring now to FIG. 3, a side view of an exemplary flanged piping assembly 300 is shown. Flanged piping assembly 300 includes a t-shaped flanged pipe 302, coupled to a first flanged pipe 304 and a second flanged pipe 306, each coupled via assembly 200.

The plate apparatus of the present invention provides several advantages over the prior art. First, the plates of the plate apparatus can be removed after assembly and re-used. The plates may be comprised of plate steel or cast aluminum, or any other suitable material that provides strength and durability. Moreover, the plates of the plate apparatus are simple and inexpensive to manufacture and distribute. Additionally, the plates do not have to be fitted or matched together during assembly. One or both plates of the plate apparatus may be used at any given time, such that if one plate of the plate apparatus is lost or damaged, the other plate can be used for the entire assembly by simply using it on the top half of the ring first and then moving it to the bottom half of the ring to complete assembly. Finally, as previously noted, the plates are fully customizable depending on the size and shape of the flange, the flange fastener configuration, and/or the fastener shape and size. In a preferred embodiment, the fastener is a bolt. However, it is contemplated that any suitable fastener that can be used to fasten flanges may be utilized with the present invention.

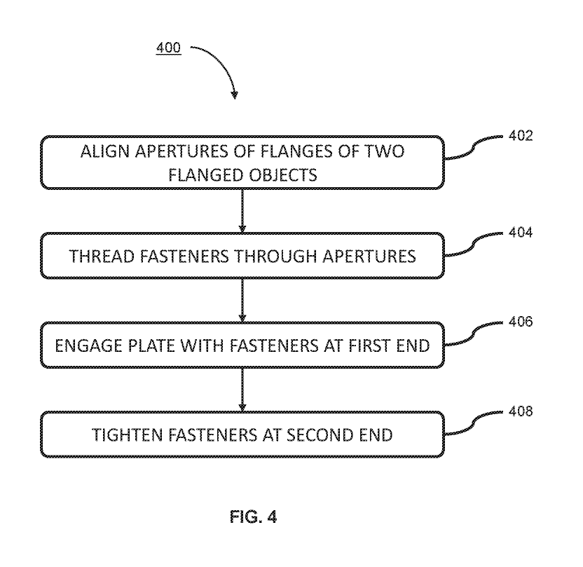

Referring now to FIG. 4, a flowchart illustrating a method for assembling flanged objects is shown. At a first step 402, a first flange containing a plurality of apertures is aligned to a second flange containing a plurality of apertures, where one of the plurality of apertures of the first flange is aligned to one of the plurality of apertures of the second flange to form a single, continuous aperture.

At a second step 404, a plurality of fasteners is threaded through each of the continuous flange apertures.

At a third step 406, at least one plate (see plate 102 of FIG. 1) is engaged with a first end of the fasteners. For instance, the at least one plate may be engaged at the first end with either the heads or nuts of a bolt.

At a fourth step 408, the fasteners are tightened at a second end (e.g., the nuts, if the first end comprises heads; or the heads, if the first end comprises nuts). The at least one plate holds the first end of the fasteners in place during the tightening to prevent movement or rotation of the first end.

The above description of illustrated examples of the present invention, including what is described in the Abstract, are not intended to be exhaustive or to be limitation to the precise forms disclosed. While specific embodiments of, and examples for, the present invention are described herein for illustrative purposes, various equivalent modifications are possible without departing from the broader spirit and scope of the present invention. Indeed, it is appreciated that the specific measurements, angles, etc., are provided for explanation purposes and that other values may also be employed in other embodiments and examples in accordance with the teachings of the present invention.

What is claimed is:

1. An apparatus for assembly of flanged objects, the apparatus comprising:
at least one plate;
a plurality of apertures on the at least one plate, the plurality of apertures spaced at predetermined intervals, wherein each of the plurality of apertures is a predetermined shape matching a shape of a first end of a fastener; and
wherein a second end of the fastener is threaded through one of the plurality of apertures such that the first end of the fastener engages with the at least one plate at the one of the plurality of apertures and prevents rotational movement of the first end of the fastener.

2. The apparatus of claim 1, wherein the at least one plate comprises two identical plates.

3. The apparatus of claim 1, wherein the plate is comprised of steel.

4. The apparatus of claim 1, wherein the plate is comprised of aluminum.

5. The apparatus of claim 1, wherein the fastener comprises a bolt.

6. The apparatus of claim 5, wherein the first end of the bolt comprises a bolt head.

7. The apparatus of claim 5, wherein the first end of the bolt comprises a nut.

8. The apparatus of claim 5, wherein the second end of the bolt comprises a bolt head.

9. The apparatus of claim 5, wherein the second end of the bolt comprises a nut.

10. The apparatus of claim 1, wherein the at least one plate comprises a half-ring shape.

11. A method for assembly of flanged objects, the method comprising:
aligning a first flange containing a plurality of apertures to a second flange containing a plurality of apertures, wherein one of the plurality of apertures of the first flange is aligned to one of the plurality of apertures of the second flange to form a plurality of continuous flange apertures;
threading a plurality of fasteners through each of the plurality of continuous flange apertures;
engaging at least one plate with a first end of the plurality of fasteners;
tightening a second end of the plurality of fasteners, such that the first end of the plurality of fasteners engage with the at least one plate at the plurality of continuous flange apertures to prevent rotational movement of the first end of the plurality of fasteners.

12. The method of claim 11, wherein the at least one plate comprises two identical plates.

13. The method of claim 11, wherein the plate is comprised of steel.

14. The method of claim 11, wherein the plate is comprised of aluminum.

15. The method of claim 11, wherein the plurality of fasteners comprise bolts.

16. The method of claim 15, wherein the first end of the bolts comprise bolt heads.

17. The method of claim 15, wherein the first end of the bolts comprises nuts.

18. The method of claim 15, wherein the second end of the bolts comprises bolt heads.

19. The method of claim 15, wherein the second end of the bolts comprises nuts.

20. The method of claim 11, wherein the at least one plate comprises a half-ring shape.
